(19) United States
(12) Patent Application Publication
(10) Pub. No.: US 2015/0066753 A1
(43) Pub. Date: Mar. 5, 2015

(54) BILL PAY SYSTEM USING BILL PAY CODE

(71) Applicant: MasterCard International Incorporated, Purchase, NY (US)

(72) Inventors: Gidget A. Hall, Town and Country, MO (US); Jill B. Bugh, Town and Country, MO (US); Joanne G. Middendorf, Powell, OH (US); Tadepally Venkata Seshadri, Singapore (SG); Vijay Agicha, Mumbai (IN); Amit Jain, Scarsdale, NY (US); Thomas Kuncheria, Dubai (AE); Donovan Yong, Singapore (SG); Pauline Ow, Chesterfield, MO (US)

(21) Appl. No.: 14/015,586

(22) Filed: Aug. 30, 2013

(51) Int. Cl. G06Q 20/10

(52) U.S. Cl. CPC G06Q 20/102
USPC 705/40

(57) ABSTRACT

Systems and methods for facilitating bill payment and presentment are provided using bill pay codes generated by a biller and validated by a bill presentment and payment system. A mobile service provider enables consumers having pre-paid mobile telephone accounts to employ embodiments of the systems and methods.

### FIELD

The present invention relates generally to the electronic and computer arts, and, more particularly, to apparatus and methods for bill payment transactions, such as presentment and payment of biller-generated invoices, and the like.

### BACKGROUND

FIG. 5 shows operation of a current electronic bill payment system, such as the MASTERCARD RPPS® electronic payment system, which is but one non-limiting example of such a system. As shown in FIG. 5, in a current approach 1000, during a presentment phase, a biller 1002 electronically sends billing information 1012 to its biller service provider (BSP) 1004; that is, an institution that acts as an intermediary between the biller and the consumer for the exchange of electronic bill payment information. BSP 1004 in turn sends the information to the electronic bill payment system 1006, as seen at 1014. As seen at 1016, the system 1006 in turn delivers the billing information to the customer service provider (CSP) 1008, that is, an agent of the customer that provides an interface directly to customers, businesses, or others for bill payment and presentment. The CSP enrolls customers, enables payment and presentment, and provides customer care. CSP 1008 presents the bill to the consumer (customer) 1010 at 1018.

In a payment phase, consumer 1010 sends bill payment instructions to CSP 1008, as seen at 1020. CSP 1008 in turn sends the bill payment information to the system 1006, as at 1022. The system sends funds and data electronically to BSP 1004, as at 1024. The BSP 1004 posts payment information to the biller 1002, as at 1026.

FIG. 6 shows a current process 1100 for making electronic funds transfers (EFT) for bill payment or the like. An originating depository financial institution (ODFI) 1102, also known as an originator, sends instructions (e.g., payment data and remittance data) using a network such as the automated clearing house (ACH) 1104, Swift, EPN, CHIPS, Fedwire, and the like, as seen at 1108. As shown at 1110, the ACH or similar network 1104 relays the instructions to the receiving depository financial institution (RDFI) (e.g., receiver or a lockbox), designated 1106. In some embodiments, an ACH file format can be used; one non-limiting example of an ACH file format is the NACHA ACH CCD file format. Other formats can also be used; for example, extensible markup language (XML). It should be noted that a variety of networks can be used, both public (for example, ACH) and proprietary (for example, the aforementioned MASTERCARD RPP® system).

### SUMMARY

Principles of the present invention provide techniques and systems related to the presentment, processing and payment of invoices. At least some aspects of the techniques may be facilitated by the operator of a payment network or other service provider.

In one aspect, an exemplary method includes promulgating, to a plurality of billers, by an operator of an electronic bill presentment and payment system, a specification for generating a cross-market unique bill payment code; and obtaining, by the electronic bill presentment and payment system, from a given one of the billers, a bill payment code in accordance with the specification. The bill payment code uniquely identifies a bill of the given one of the billers. Additional steps include obtaining, by the electronic bill presentment and payment system, from an entity associated with a party owing payment to the given one of the billers for the bill of the given one of the billers, the bill payment code in accordance with the specification, together with associated bill payment information; matching, by the electronic bill presentment and payment system, the bill payment code obtained from the given one of the billers with the bill payment code obtained from the entity associated with the party owing payment to the given one of the billers; and, if the matching is positive, the electronic bill presentment and payment system causing payment to be made to the given one of the billers for the bill of the given one of the billers, in accordance with the associated bill payment information, and the electronic bill presentment and payment system causing remittance information to be routed to the given one of the billers for the bill of the given one of the billers, in accordance with the associated bill payment information.

In another aspect, another exemplary method includes maintaining, by a mobile service provider, a plurality of pre-paid mobile telephone accounts for a plurality of consumers; and obtaining, by the mobile service provider, from a given one of the consumers, a bill payment code in accordance with a specification promulgated to a plurality of billers by an operator of an electronic bill presentment and payment system, together with associated bill payment information. The bill payment code and the associated bill payment information are associated with a bill from a given one of the billers to the given one of the consumers, and the given one of the billers is separate and distinct from the mobile service provider. Further steps include debiting, by the mobile service provider, one of the pre-paid mobile telephone accounts corresponding to the given one of the consumers, in accordance with the associated bill payment information; and sending, by the mobile service provider, to the electronic bill presentment and payment system, the bill payment code and the associated bill payment information.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. The means are defined to exclude a transmission medium per se or disembodied signal per se.

One or more embodiments of the invention can provide substantial beneficial technical effects, including any one, some, or all of the following:
reduction of potential errors in bill presentment and payment processing;
ability to securely track a payment from beginning to end;
enhanced security of payment in jurisdictions without well-developed credit rating agencies.

These and other features and advantages of the present inventions will become apparent from the following detailed description of illustrative embodiments thereof, which is to be read in connection with the accompanying drawings.

### BRIEF DESCRIPTION OF THE DRAWINGS

FIG. 1 shows a bill payment system in accordance with an exemplary embodiment and an exemplary bill presentment steps employed therein;

FIG. 2 shows a bill payment system in accordance with the exemplary embodiment of FIG. 1 and an exemplary payment steps employed therein;

FIG. 3 shows a bill payment system in accordance with a further exemplary embodiment and exemplary bill presentment and payment steps employed therein;

FIG. 4 is a block diagram of an exemplary computer system useful in one or more embodiments of the invention;

FIG. 5 shows exemplary operation of a current bill payment system;

FIG. 6 shows exemplary operation of current automated clearinghouse payments;

FIG. 7 is an exemplary software architecture diagram of a bill presentment and payment system platform according to a further exemplary embodiment; and

FIG. 8 is an exemplary software architecture diagram for a mobile service provider, according to a further exemplary embodiment.

### DETAILED DESCRIPTION

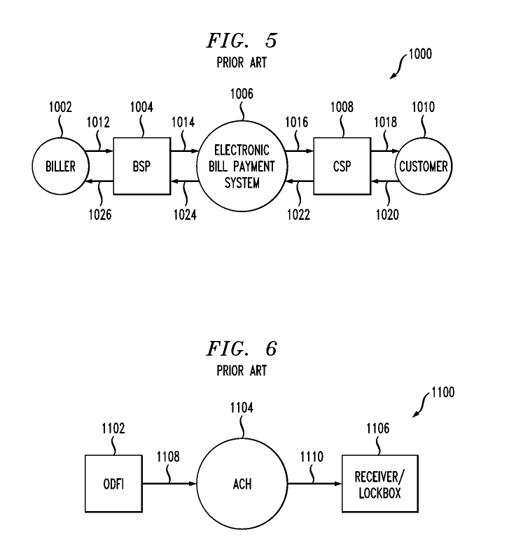

Inventive techniques can be employed in a number of different environments. In one or more embodiments, inventive techniques can be employed in connection with the MASTERCARD RPPS® electronic payment system of MasterCard International Incorporated of Purchase, N.Y., USA. This example is non-limiting; for example, other types of electronic bill payment systems could be employed in other instances. Thus, references to RPPS in one or more embodiments are not intended to be limiting and other embodiments may be employed in connection with other types of electronic payment systems. Given the teachings hereinbelow, the skilled artisan will be able to implement one or more embodiments of the invention using a variety of techniques; by way of example and not limitation, the modification or supplementing of an existing system such as that shown in FIG. 5 using techniques described herein, or the complete replacement of such a system, in other instances.

Exemplary Presentment Flow

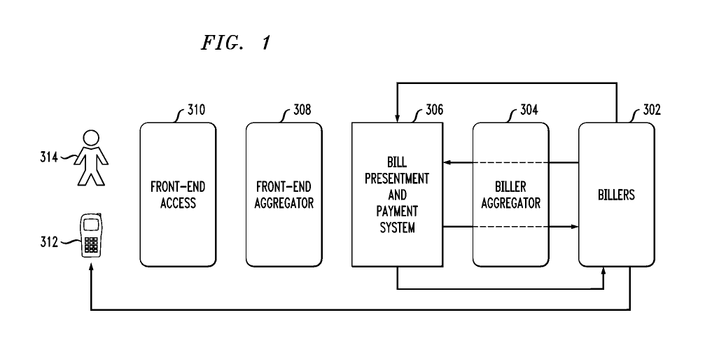

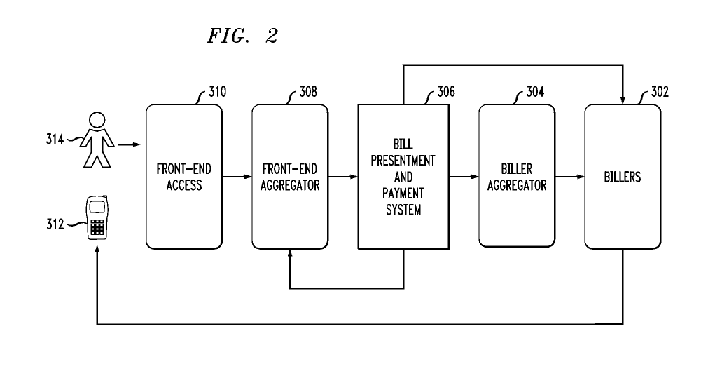

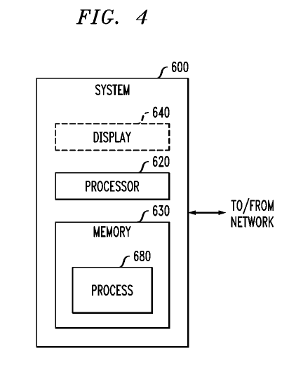

FIG. 1 depicts an exemplary bill pay system having an exemplary presentment flow according to an aspect of the invention. In a first presentment step, a biller 302 generates an invoice to a customer 314. The invoice is embedded by the biller with a bill pay code in accordance with a pertinent specification. In some cases, the specification is promulgated by an entity such as the operator of a bill presentment and payment system (BPPS) 306. In some cases, the operator of BPPS 306 is also the operator of a payment network that processes payment card payments and the like (e.g., MasterCard International Incorporated of Purchase, N.Y., USA or Visa Inc. of San Francisco, Calif., the operator of the VisaNet payments network). Reference is made to US Patent Publication US 2011-0251952 A1 of Mary L. Kelly et al., especially FIGS. 1-2 thereof and accompanying text, and to US Patent Publication US 2012-0197788 A1 of Hemal Sanghvi et al., especially FIGS. 1-2 thereof and accompanying text. US Patent Publication US 2011-0251952 A1 and US Patent Publication US 2012-0197788 A1 are both hereby expressly incorporated by reference herein in their entireties for all purposes. In a second step, which in some cases, is carried out contemporaneously with the first step, the biller 302 sends the bill pay code to the bill presentment and payment system 306. A non-limiting example of such a bill presentment and payment system is the MASTERCARD RPPS® system available from MasterCard International Inc., Purchase, N.Y., USA. One such bill presentment and payment system is described in U.S. Pat. No. 5,699,528 assigned to MasterCard International, Inc., which is incorporated by reference herein. Another is disclosed in U.S. Pat. No. 7,756,786, also incorporated by reference herein. The second step is represented by the arrows from biller 302 to bill presentment and payment system 306. In some cases, the biller 302 sends the bill pay code electronically to the bill presentment and payment system 306 via biller aggregator 304 (arrow passing through biller aggregator); in other instances, communication is directly between the biller 302 and the system 306 (arrow passing around aggregator). In some cases, the biller 302 sends the bill pay code to the bill presentment and payment system 306 electronically in a batch file, but a service call (i.e. real-time processing as opposed to batch; a real-time query to the system via a service call) can also be employed. This feed does not require any customer data, though in some embodiments includes the mobile phone number of the customer where a mobile phone is employed as a payment device and/or front end access point. The biller maintains the relationship between the bill pay code and the bill/customer account. It will be appreciated that the biller may utilize a biller computing apparatus including a memory and at least one processor that is coupled to the memory and operative to generate the invoice and the bill pay code and perform one or more of the steps described below with respect to functions performed by the biller. FIG. 4 shows an exemplary system 600 that includes a biller computing apparatus in accordance with some embodiments.

In a third step, the bill presentment and payment system 306 stores and validates the bill pay code(s) for later matching to payments from customers such as customer 314. In a fourth step, the bill presentment and payment system 306 sends a response to the biller 302 to confirm validation and storage of the bill pay code(s). The fourth step is represented by the arrows from bill presentment and payment system 306 to biller 302 (communication can be directly between system 306 and biller 302, as represented by the arrow passing around biller aggregator 304, or via aggregator 304, as represented by the arrow passing through aggregator 304). The bill presentment and payment system may include one or more processors coupled to one or more memories for performing the functions described herein, FIG. 6 showing one exemplary system. In a fifth step, the biller 302 sends the bill pay code to the customer 314 through SMS to the customer's cell phone 312 or the like. The bill pay code is included with an invoice in this exemplary embodiment. The fifth step is represented by the arrow from biller 302 to customer 314 and the customer's mobile phone 312. The skilled artisan will appreciate that Short Message Service (SMS) is a text messaging service component of phone, web, or mobile communication systems, using standardized communications protocols that allow the exchange of short text messages between fixed line or mobile phone devices.

When the customer receives the invoice, whether via a mobile channel or paper, the customer employs front-end access 310, such as an on-line bill pay web site or the mobile phone 312. Via the front-end access 310, the front-end aggregator 308 collects and consolidates all the payment information and forwards same with the bill pay code to the bill presentment and payment system 306. Bill presentment and payment system 306 checks the collected, consolidated information against the bill pay codes validated and stored in the third step described above. If there is a match for a given bill pay code, the payment information can be reconciled, and same is processed and sent back to the biller 302 via the biller aggregator 304. Further details are provided in FIG. 4 and accompanying text.

The generation of the invoice can be carried out with any suitable software program; many types are commercially available and well-known to the skilled artisan. The bill pay code, as noted, is defined in one or more embodiments in a specification (e.g., a schema or algorithm) promulgated by an operator of a payment network that processes payment card payments, as discussed above, or the like. The bill pay code may include, for example, any one, some, or all of the following information and/or additional information:
country code
biller information (e.g., biller name and related information)
biller identification (e.g., information that will identify the biller; for example, an assigned number recognized by both receiving and sending parties)
consumer identification
currency
amount payable in local currency
date (due date and optionally also bill generation date)

The biller 302 is provided (e.g., by an operator of a payment network 2008 or the like) with the schema or algorithm allowing the biller to generate unique bill pay codes. The biller is provided with the information to populate the required fields. Since the biller has a unique identifier which is included in the bill pay code, each invoice only needs a code segment that is unique within that biller. That is to say, Biller 01 and Biller 02 can each have an invoice associated with a code segment 20345, but since they have separate and distinct biller identifiers, there is no confusion. In some embodiments, a “payment slip reference number” includes unique (e.g. GLN) and non-unique (e.g. amount payable) information. In one exemplary embodiment, company (biller) identifiers assigned through the GS1 System are employed as unique identifiers including the bill pay codes. The Global Location Number is one exemplary tool used in accordance with the GS1 system of standards to identify an entity and a physical location.

In one or more embodiments, the unique bill pay code travels along with the payment cycle to allow for tracing from initiation all the way to payment posting at the end of the cycle.

In the second step, in some embodiments, the unique bill pay code is all that needs to be sent from the biller 302 to the bill presentment and payment system 306. Indeed, where the bill pay code is sufficiently sophisticated, it will include the identification of the biller, the dollar amount, the date, and any other required information. In an alternative embodiment using bill pay codes having less information, additional required information could be sent along in an accompanying file or the like. In some cases, in the inbound communication from the customer 314, it may be desirable to include additional information besides the code.

In some cases, the bill pay codes are sent from billers 302 to bill presentment and payment system 306 in the above-mentioned second step using the global file transfer (GFT) system. GFT facilitates a straight transfer from one party to another, taking advantage of in-place connectivity without offering file transfer protocol (FTP) services. A straight transfer may be carried out because of a relationship with a member and a vendor or third party. As will be appreciated by the skilled artisan, GFT is a system employed by MasterCard International Incorporated wherein files are transferred over a payment network that processes payment card payments, as discussed above; GFT is a non-limiting example of data file transfer via a payment network. FTP is the standard network protocol used to exchange and manipulate files over an Internet Protocol computer network, such as the Internet. Appropriate file retention and/or billing policies can be set within a GFT network. Any suitable technique can be used the send the bill pay codes; e.g., by communication over a computer network or internetwork (e.g. the Internet). With regard to the above-mentioned third step, bill presentment and payment system 306 checks the received bill pay codes against the aforementioned schema. If the received bill pay codes are valid under the rules of the schema, then they are placed in a database, data warehouse, data structure, or the like to be matched against bill pay codes received from customers 314. If they are not valid, an error message is generated to advise the biller. Examples of invalidity include a country code that is invalid, biller information that does not register, and so on. Thus, the above-mentioned fourth step includes a confirmation for valid bill pay codes received and an error message for invalid bill pay codes received.

With regard to the checking or validation process, the same can include a file integrity check, schema checking, and so on. Some embodiments can employ Java code for the checking or validation process, but other embodiments could use different approaches.

Thus, in some instances, an entity such as the operator of BPPS 306, which can in some cases be the operator of a payment network that processes payment card payments and the like, provides a specification including a suitable schema and/or algorithm to billers 302 to allow them to generate the unique bill pay codes.

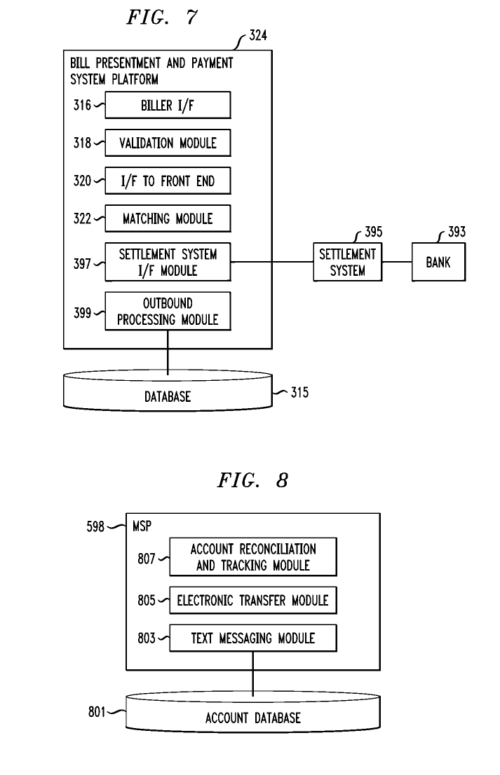

In some instances, a biller interface module 316 as shown in FIG. 7 is provided as part of a bill presentment and payment system platform 324 to permit the bill presentment and payment system 306 to interface with billers 302 and/or biller aggregator 304. A validation module 318 is further provided to permit the bill presentment and payment system 306 to check bill pay codes received from the biller(s) 302 against the schema in some embodiments. Thus, the first step is carried out by the biller using any standard invoicing software, but with the unique bill pay code generated in accordance with the aforementioned schema or algorithm. The second step is carried out by the biller using, for example, the biller's invoicing software, augmented as needed with additional custom program instructions and the bill pay codes are received by the bill presentment and payment system 306 via the interface module. The third step is carried out by bill presentment and payment system 306 via the validation module 318, with storage in a suitable database 315. The fourth step is carried out by bill presentment and payment system 306 via the biller interface module 316.

With regard to the fifth step, in one or more embodiments, the biller 302 communicates with the customer 314 using multiple channels. An ordinary paper invoice can be sent or otherwise provided. An online bill presentment service can be utilized. A mobile SMS message can be utilized. Thus, broadly, the bill pay code is communicated from the biller to the customer using any suitable technique, along with sufficient information so that the customer knows what bill it pertains to, e.g., August telephone bill.

It should be noted that first through fifth presentment steps have been described above. However, the description of the particular order is not meant to limit the scope of the invention unless expressly recited in the claims. Other orders of steps can be used in other embodiments, or one or more steps can be carried out contemporaneously. For example, as shown, the fifth step is carried out after steps 1-4 such that only a bill pay code confirmed by bill presentment and payment system 306 to be valid is sent to the customer 314. However, steps two and five could be carried out simultaneously to get the bill pay code to the customer more quickly, but at the risk of possibly sending the customer an invalid bill pay code.

Exemplary Payment Flow

FIG. 2 depicts the bill pay system as shown in FIG. 1 and an exemplary payment flow. In a first payment step, the payment flow is initiated by the consumer 314, using the front-end access 310, as indicated by the arrow from the consumer 314 to the front-end access 310. Front-end access 310 could include, for example, an on-line bill payment tool, a walk-in payment at a brick and mortar location, a mobile application on phone 312 or other device, or any other suitable interface. The consumer 314 already knows the bill pay code, having received it via SMS or other suitable vehicle from a biller 302. Thus, in a second payment step, indicated by the arrow from the front-end access 310 to the front-end aggregator 308, the access point 310 accepts payment from the consumer 314 and the bill pay code is included in payment details sent to the front-end aggregator 308. The front-end aggregator 308 receives the bill pay code along with the payment details, and in a third payment step, indicated by the arrow from the front-end aggregator 308 to the bill presentment and payment system 306, sends the bill pay code along with the payment details to bill presentment and payment system 306. In a fourth payment step, bill presentment and payment system 306 validates (matches) the bill pay code against the information that was validated and stored in the database 315 in the third presentment step, using the validation module 318; maps the payment to the appropriate biller 302, and routes the payment to the appropriate biller aggregator 304. As shown in FIG. 7, a front end interface module 320 is provided in some exemplary embodiments to receive inputs from the front end aggregator 308 while a matching module 322 determines whether the bill pay code received from the front end aggregator matches that previously provided by the biller apparatus. Since each bill pay code is unique, the process of validating the bill pay code against the stored information can be carried out, for example, via any of a number of well-known database-querying techniques, of which a SQL script is a non-limiting example, to query for the exact bill pay code in a database (e.g., database 315).

In part “a” of a fifth payment step, BPPS 306 sends a response to front-end aggregator 308, optionally in near-real-time. This is indicated by the arrow from BPPS 306 to front-end aggregator 308. Where the fourth step indicated validity, this response is a confirmation. If the bill pay code could not be validated in the fourth step, the response is a non-confirmation. In part “b” of the fifth payment step, BPPS 306 sends remittances to biller aggregator 304, optionally in near-real-time, assuming the bill code has been validated. This is indicated by the arrow from BPPS 306 to biller aggregator 304. In a sixth payment step, biller aggregator 304 sends the bill pay code to the biller 302, as indicated by the arrow from biller aggregator 304 to the biller 302. This allows the payment to be posted and reconciled, and to ensure that the consumer is credited with making payment. The remittance can also be sent to the biller by the biller aggregator or the biller aggregator's bank. Again, as described with regard to FIG. 1, in some cases BPPS communicates directly with biller 302, not via aggregator 304, as indicated by the arrow from BPPS 306 to biller 302 that does not pass through aggregator 304.

In an optional seventh payment step, biller 302 maps the received bill pay code to the customer 314 and sends a payment acknowledgement back to the customer via SMS or some other channel, as indicated by the arrow from biller 302 to the device 312 and customer 314. It will be appreciated that the steps described above with respect to payment flow may not necessarily be performed sequentially. For example, parts “a” and “b” of the fifth payment steps can be performed sequentially or simultaneously. Furthermore, in regard to the first and second payment steps, a variety of payment methods can be used; for example, a payment card, a demand deposit, cash in a brick and mortar location, and so on.

In some embodiments, settlement can be carried out using a business as usual (BAU) batch process, while for reconciliation, use can be made of the bill pay code. Settlement may be done in real-time or near-real-time in other embodiments. The use of the bill pay code advantageously reduces or eliminates potential human errors in entering data such as the amount to be paid, the biller identification, consumer account numbers, or other information. In some embodiments, an invoice from the biller includes a bar code including the bill pay code that can be scanned by the consumer at the front end access 310 at the time of payment, ensuring the consumer's account with the biller is properly credited. Bar codes meeting GS1 application standards are among the options available in some embodiments.

Pre-Paid Mobile Bill Payment Flow

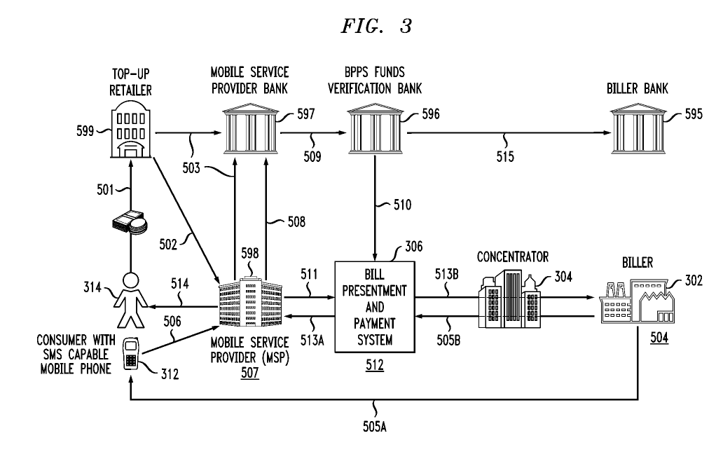

FIG. 3 depicts a bill payment system and an exemplary pre-paid mobile bill payment flow. The consumer 314 in this exemplary system uses a mobile device 312 such as a mobile telephone. In step 501, when he or she wishes to top-up his or her mobile account, he or she visits a facility that enables such activity such as a top-up retailer 599 and tops up his or her pre-paid mobile account with cash. In step 502, the consumer's pre-paid account is credited by the mobile service provider (MSP) 598. In step 503 (optionally at the same time as step 502), the consumer's cash is deposited in the mobile service provider's bank 597 or other financial institution, via the retailer 599 or the MSP 598.

In step 504, also shown in FIG. 3, biller 302 generates a unique bill pay code in accordance with the above-discussed schema or algorithm meeting BPPS 306 specifications. In step 505A, the bill, with the unique bill pay code, is sent by the biller 302 to the customer 314 (e.g., via SMS to customer's mobile phone 312). In step 505B, the biller sends the bill pay code to BPPS 306, optionally via a concentrator 304, or directly. Steps 505A and 505B are conducted simultaneously in some embodiments and sequentially in other embodiments. Suitable modes of sending include, for example, a file (e.g., batch process) or a service call (i.e. real-time communication). Note that a “concentrator” as used herein is synonymous with a “biller aggregator.” BPPS 306 stores the bill pay code in electronic database 315.

Consumer 314 receives the bill on his or her device 312 following step 505A and, in this exemplary embodiment, concludes that the bill is valid and he or she wishes to make payment. In step 506, the consumer forwards the bill SMS message to MSP 598 for payment. The consumer can be provided with a suitable “mobile app” on his or her phone to facilitate this process. The bill pay code is included in this communication. In step 507, the MSP debits the consumer's pre-paid account. In step 508, MSP 598 sends the bill payment total for each individual transaction to the MSP's bank 597. In step 509, the bill payment funds are wired to the BPPS funds verification bank 596. Bank 596 has an account opened by the operator of BPPS 306 and dedicated for use with the process depicted in FIG. 5. MSP bank 597, in some embodiments, collects and consolidates payment for a number of transactions and sends funds for same to BPPS fund verification bank 596 in step 509.

In step 510, BPPS funds verification bank 596 sends to BPPS 306 an indication that information was received from certain bank(s) 597 paying for certain customer(s) 314. This aspect is helpful when dealing with an entity such as MSP 598 or aggregator 308, which is not a bank and is not sponsored by a bank; BPPS 306 is thereby assured that funds are available before settlement. Bank 596 advises BPPS 306 of the maximum amount that can be processed for a particular biller, based on the communication from MSP bank 597. In step 511, MSP 598 aggregates the payment information collected via the mobile phone(s) 312 and sends this information to BPPS 306 with the applicable unique bill pay code(s). In some cases, steps 509 and 511 are performed in parallel. In step 512, BPPS 306 matches and validates the information; namely, that funds have been received and that the bill pay code(s) match those received in step 505B. In step 513A, BPPS 306 sends a confirmation to the MSP 598 used by the consumer 314, while in step 513B, BPPS 306 sends remittances to biller(s) 302, optionally via concentrator(s) 304. Steps 513A and 513B may be conducted sequentially or simultaneously.

In step 514, the MSP 598 sends a confirmation to the consumer 314 via SMS, enabling the consumer to note the same by reference to the mobile telephone 312. SMS confirmation, which is shown in this exemplary embodiment as being sent to the consumer 314 by the MSP 598, could alternatively be sent by the BPPS 306 or the biller 302. In step 515, settlement occurs between BPPS funds verification bank 596 and biller bank 595.

For the avoidance of doubt, FIG. 3 depicts an exemplary model wherein consumer(s) 314 have pre-paid mobile phone accounts which are funded by periodically making payments at a location such as facility 599. Functionality of these accounts is expanded in the embodiment, such that they can be used as payment vehicles to pay, out of funds in the pre-paid mobile account, any kind of bill (not limited to a mobile phone bill) for any kind of biller 302 that has availed itself of the unique bill pay code process.

Given the discussion thus far, it will be appreciated that, in general terms, an exemplary method, according to an aspect of the invention, includes the step of promulgating, to a plurality of billers 302, by an operator of an electronic bill presentment and payment system 306, a specification for generating a cross-market unique bill payment code. As used herein, a “cross-market” code is a universal code that works in many jurisdictions; the payments can be in a single jurisdiction or multiple jurisdictions (cross-border). A “cross-market” code thus complies with international standards. A further step includes obtaining, by the electronic bill presentment and payment system 306, from a given one of the billers 302, a bill payment code in accordance with the specification. The bill payment code uniquely identifies a bill of the given one of the billers. Refer to step 505B and in FIG. 1, the arrows from 302 to 306. A still further step includes obtaining, by the electronic bill presentment and payment system 306, from an entity associated with a party (e.g., 314) owing payment to the given one of the billers for the bill of the given one of the billers, the bill payment code in accordance with the specification, together with associated bill payment information. Refer to step 511 and in FIG. 2, the arrows from 310/308 to 306. Even further steps include matching, by the electronic bill presentment and payment system 306, the bill payment code obtained from the given one of the billers with the bill payment code obtained from the entity associated with the party owing payment to the given one of the billers (refer to step 512, and in FIG. 2, mapping within block 306); and, if the matching is positive, the electronic bill presentment and payment system 306 causing payment to be made to the given one of the billers 302 for the bill of the given one of the billers, in accordance with the associated bill payment information, and the electronic bill presentment and payment system causing remittance information to be routed to the given one of the billers 302 for the bill of the given one of the billers, in accordance with the associated bill payment information. Refer to FIG. 3 steps 515 and 513B, and in FIG. 2, the arrows from 306 to 302.

In some instances, the electronic bill presentment and payment system validates the bill payment code obtained from the given one of the billers. This is implicit in step 505B, and in FIG. 1, occurs within block 306. A further step includes confirming, to the given one of the billers, the validation of the bill payment code obtained from the given one of the billers. Refer to step 513A, and in FIG. 1, the arrow from block 306 to block 302.

In some embodiments, an additional step includes the electronic bill presentment and payment system confirming the positive matching to the entity associated with the party owing payment to the given one of the billers. This is implicit in step 505B; in FIG. 2, refer to the arrow from block 306 to block 308.

The aforementioned entity associated with the party 314 owing payment to the given one of the billers can include, for example, a front end aggregator 308, a mobile telephony service provider 507 that is separate and distinct from the given one of the billers 302, and the like.

In some instances, in the obtaining steps, the bill payment code includes amount due, due date, an identification of the given one of the billers, and an identification of the party owing payment to the given one of the billers.

In at least some embodiments, a further step includes providing a system, wherein the system includes distinct software modules. Each of the distinct software modules is embodied on a non-transitory computer-readable storage medium. The distinct software modules include a biller interface module 316, an entity interface module, and a matching module 322. Note that the entity interface module can include, for example, front end interface 320 for FIGS. 1 and 2 and an interface to MSP 507 for FIG. 3. In such embodiments, the obtaining of the bill payment code from the given one of the billers is carried out by the biller interface module executing on at least one hardware processor; the obtaining of the bill payment code and the associated bill payment information from the entity associated with the party owing payment to the given one of the billers is carried out by the entity interface module executing on the at least one hardware processor; and the matching is carried out by the matching module executing on the at least one hardware processor.

In at least some embodiments, with regard to remittances, database 315 stores, inter alia, preferences for a biller and/or a biller concentrator. Optional outbound processing module 399 senses when a payment is occurring, looks up the preferences in database 315, and prepares a batch file that is sent to the biller or biller concentrator in due course. With regard to payments (settlement), a settlement system 395 implemented via a settlement processing module, optionally separate from BPPS 324, but optionally within the purview of the operator of BPPS 306, is signaled via interface 397 and in response sends a message to bank 393 to cause settlement.

In another aspect, an exemplary method includes the step (see, e.g., step 502) of maintaining, by a mobile service provider 598, a plurality of pre-paid mobile telephone accounts for a plurality of consumers. A further step 506 includes obtaining, by the mobile service provider 598, from a given one of the consumers 314, a bill payment code in accordance with a specification promulgated to a plurality of billers by an operator of an electronic bill presentment and payment system, together with associated bill payment information. The bill payment code and the associated bill payment information are associated with a bill from a given one of the billers 302 to the given one of the consumers 314. The given one of the billers is separate and distinct from the mobile service provider. A further step 507 includes debiting, by the mobile service provider 598, one of the pre-paid mobile telephone accounts corresponding to the given one of the consumers, in accordance with the associated bill payment information. An even further step 511 includes sending, by the mobile service provider 598, to the electronic bill presentment and payment system 306, the bill payment code and the associated bill payment information. A further optional step 508 includes the mobile service provider causing payment of the bill from the given one of the billers to be initiated.

In at least some embodiments, a further step includes providing a system, wherein the system includes distinct software modules. Each of the distinct software modules is embodied on a non-transitory computer-readable storage medium, and, as seen in FIG. 8, the distinct software modules include an account database module 801, a text messaging module 803, an electronic transfer module 805, and an account reconciliation and tracking module 807. The maintaining, by the mobile service provider, of the plurality of pre-paid mobile telephone accounts, is carried out by the account database module 801 executing on at least one hardware processor; and the obtaining, by the mobile service provider, from the given one of the consumers, of the bill payment code together with associated bill payment information, is carried out by the text messaging module 803 executing on the at least one hardware processor. Furthermore, the debiting, by the mobile service provider, of the one of the pre-paid mobile telephone accounts is carried out by the account reconciliation and tracking module 807 executing on the at least one hardware processor; and the sending, by the mobile service provider, to the electronic bill presentment and payment system, of the bill payment code and the associated bill payment information, is carried out by the electronic transfer module 805 executing on the at least one hardware processor.

Module 803 can include, for example, Short Message Service (SMS) or similar capability, in some instances, with capability for encryption and/or other security capability.

In another aspect, one or more embodiments of the invention or elements thereof can be implemented in the form of a system (or apparatus) including a memory and at least one processor that is coupled to the memory and operative to perform method steps as described. In some cases, the at least one processor is operative to perform the steps when instructions, tangibly stored in a non-transitory manner on a computer readable storage medium (e.g., the modules mentioned elsewhere herein), are loaded into the memory for execution by the at least one processor.

In still another aspect, an article of manufacture includes a computer program product, and the computer program product in turn includes a tangible computer-readable recordable storage medium, storing in a non-transitory manner computer readable program code. The computer readable program code includes computer readable program code (e.g., the modules mentioned elsewhere herein) configured to carry out or otherwise facilitate any one, some, or all of the method steps herein; for example, when loaded into a memory and executed by a processor.

### System and Article of Manufacture Details

Embodiments of the invention can employ hardware and/or hardware and software aspects. Software includes but is not limited to firmware, resident software, microcode, etc. Purely by way of further example and not limitation, functionality of the elements in FIGS. 1-3 can be implemented by suitable software modules executing on hardware processors of servers or other general purpose computers, mobile phones, tablets, and the like.

FIG. 4 is a block diagram of a system 600 that can implement part or all of one or more aspects or processes of the invention. As shown in FIG. 4, memory 630 configures the processor 620 (which could correspond, e.g., to processors of hosts and/or servers implementing various functionality, processors associated with any entities as depicted in the figures (e.g., smart phone or tablet), and the like) to implement one or more aspects of the methods, steps, and functions disclosed herein (collectively, shown as process 680 in FIG. 4). Different method steps can be performed by different processors. The memory 630 could be distributed or local and the processor 620 could be distributed or singular. The memory 630 could be implemented as an electrical, magnetic or optical memory, or any combination of these or other types of storage devices. It should be noted that if distributed processors are employed, each distributed processor that makes up processor 620 generally contains its own addressable memory space. It should also be noted that some or all of computer system 600 can be incorporated into an application-specific or general-use integrated circuit. For example, one or more method steps could be implemented in hardware in an ASIC rather than using firmware. Display 640 is representative of a variety of possible input/output devices (e.g., displays, mice, keyboards, touchscreens, and the like).

The notation “to/from network” is indicative of a variety of possible network interface devices for interfacing with wired and/or wireless networks.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal or cellular telephone or tablet and another device could be a physical memory media associated with a processing center. As used herein, a tangible computer-readable recordable storage medium is defined to encompass a recordable medium, examples of which are set forth above, but is defined to exclude a transmission medium per se or disembodied signal per se.

The computer systems and servers described herein each contain a memory that will configure associated processors to implement the methods, steps, and functions disclosed herein. Such methods, steps, and functions can be carried out, e.g., by processing capability on the various elements, platforms, and so on, processors associated with any entities as depicted in the figures, and the like, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, processors associated with any entities as depicted in the figures; and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable storage medium. Further, one or more embodiments of the invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 600 as shown in FIG. 4) running a server program. It will be understood that such a physical server may or may not include a display, keyboard, or other input/output components. A “host” includes a physical data processing system (for example, system 600 as shown in FIG. 4) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures (e.g., servers, engines, hosts, queues, databases, and so on). In some instances, the modules include the platform 324, modules 318, 322, 399, 395, and interfaces 316, 320, 397 with suitable functionality for querying database 315, and/or modules 803, 805, 807, optionally suitable interfaces, and with suitable functionality for querying database 801. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Thus, aspects of the invention can be implemented, for example, by one or more appropriately programmed general purpose computers, such as, for example, servers or personal computers, smart phones, tablets, or the like, located at one or more of the entities in the figures, as well as within the payment network. Such computers can be interconnected, for example, by one or more of a payment processing network, another VPN, the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic and/or data flow depicted in the figures.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention. For example, items listed as mandatory in some exemplary embodiments may be optional in others, and vice versa.

What is claimed is:

1. A method comprising the steps of:
promulgating, to a plurality of billers, by an operator of an electronic bill presentment and payment system, a specification for generating a cross-market unique bill payment code;
obtaining, by said electronic bill presentment and payment system, from a given one of said billers, a bill payment code in accordance with said specification, said bill payment code uniquely identifying a bill of said given one of said billers;
obtaining, by said electronic bill presentment and payment system, from an entity associated with a party owing payment to said given one of said billers for said bill of said given one of said billers, said bill payment code in accordance with said specification, together with associated bill payment information;
matching, by said electronic bill presentment and payment system, said bill payment code obtained from said given one of said billers with said bill payment code obtained from said entity associated with said party owing payment to said given one of said billers; and
if said matching is positive, said electronic bill presentment and payment system causing payment to be made to said given one of said billers for said bill of said given one of said billers, in accordance with said associated bill payment information, and said electronic bill presentment and payment system causing remittance information to be routed to said given one of said billers for said bill of said given one of said billers, in accordance with said associated bill payment information.

2. The method of claim 1, further comprising said electronic bill presentment and payment system:
validating said bill payment code obtained from said given one of said billers; and
confirming said validation of said bill payment code obtained from said given one of said billers to said given one of said billers.

3. The method of claim 2, further comprising said electronic bill presentment and payment system confirming said positive matching to said entity associated with said party owing payment to said given one of said billers.

4. The method of claim 3, wherein said entity associated with said party owing payment to said given one of said billers comprises a front end aggregator.

5. The method of claim 3, wherein said entity associated with said party owing payment to said given one of said billers comprises a mobile telephony service provider that is separate and distinct from said given one of said billers.

6. The method of claim 1, wherein, in said obtaining steps, said bill payment code comprises amount due, due date, an identification of said given one of said billers, and an identification of said party owing payment to said given one of said billers.

7. The method of claim 1, further comprising providing a system, wherein the system comprises distinct software modules, each of the distinct software modules being embodied on a non-transitory computer-readable storage medium, and wherein the distinct software modules comprise a biller interface module, an entity interface module, and a matching module;
wherein:
said obtaining of said bill payment code from said given one of said billers is carried out by said biller interface module executing on at least one hardware processor;
said obtaining of said bill payment code and said associated bill payment information from said entity associated with said party owing payment to said given one of said billers is carried out by said entity interface module executing on said at least one hardware processor; and
said matching is carried out by said matching module executing on said at least one hardware processor.

8. A method comprising the steps of:
maintaining, by a mobile service provider, a plurality of pre-paid mobile telephone accounts for a plurality of consumers;
obtaining, by said mobile service provider, from a given one of said consumers, a bill payment code in accordance with a specification promulgated to a plurality of billers by an operator of an electronic bill presentment and payment system, together with associated bill payment information, said bill payment code and said associated bill payment information being associated with a bill from a given one of said billers to said given one of said consumers, said given one of said billers being separate and distinct from said mobile service provider;
debiting, by said mobile service provider, one of said pre-paid mobile telephone accounts corresponding to said given one of said consumers, in accordance with said associated bill payment information; and
sending, by said mobile service provider, to said electronic bill presentment and payment system, said bill payment code and said associated bill payment information.

9. The method of claim 8, further comprising said mobile service provider causing payment of said bill from said given one of said billers to be initiated.

10. The method of claim 8, further comprising providing a system, wherein the system comprises distinct software modules, each of the distinct software modules being embodied on a non-transitory computer-readable storage medium, and wherein the distinct software modules comprise an account database module, a text messaging module, an electronic transfer module, and an account reconciliation and tracking module;
wherein:
said maintaining, by said mobile service provider, of said plurality of pre-paid mobile telephone accounts, is carried out by said account database module executing on at least one hardware processor;
said obtaining, by said mobile service provider, from said given one of said consumers, said bill payment code together with associated bill payment information, is carried out by said text messaging module executing on said at least one hardware processor;
said debiting, by said mobile service provider, of said one of said pre-paid mobile telephone accounts is carried out by said account reconciliation and tracking module executing on said at least one hardware processor; and
said sending, by said mobile service provider, to said electronic bill presentment and payment system, of said bill payment code and said associated bill payment information, is carried out by said electronic transfer module executing on said at least one hardware processor.

11. An article of manufacture comprising a computer program product, said computer program product comprising:
a tangible computer-readable recordable storage medium, storing in a non-transitory manner computer readable program code, the computer readable program code comprising:
computer readable program code configured to obtain, by an electronic bill presentment and payment system, from a given one of a plurality of billers, a cross-market unique bill payment code in accordance with a specification promulgated by an operator of said electronic bill presentment and payment system, said bill payment code uniquely identifying a bill of said given one of said billers;
computer readable program code configured to obtain, by said electronic bill presentment and payment system, from an entity associated with a party owing payment to said given one of said billers for said bill of said given one of said billers, said bill payment code in accordance with said specification, together with associated bill payment information;
computer readable program code configured to match, by said electronic bill presentment and payment system, said bill payment code obtained from said given one of said billers with said bill payment code obtained from said entity associated with said party owing payment to said given one of said billers; and
computer readable program code configured to, if said matching is positive:
cause said electronic bill presentment and payment system to initiate payment to said given one of said billers for said bill of said given one of said billers, in accordance with said associated bill payment information, and
cause said electronic bill presentment and payment system to initiate remittance information routing to said given one of said billers for said bill of said given one of said billers, in accordance with said associated bill payment information.

12. The article of manufacture of claim 11, further comprising computer readable program code configured to cause said electronic bill presentment and payment system to:
validate said bill payment code obtained from said given one of said billers; and
confirm said validation of said bill payment code obtained from said given one of said billers to said given one of said billers.

13. The article of manufacture of claim 12, further comprising computer readable program code configured to cause said electronic bill presentment and payment system to confirm said positive matching to said entity associated with said party owing payment to said given one of said billers.

14. The article of manufacture of claim 13, wherein said entity associated with said party owing payment to said given one of said billers comprises a front end aggregator.

15. The article of manufacture of claim 13, wherein said entity associated with said party owing payment to said given one of said billers comprises a mobile telephony service provider that is separate and distinct from said given one of said billers.

16. The article of manufacture of claim 11, wherein, in said computer readable program code configured to cause said obtaining, said bill payment code comprises amount due, due date, an identification of said given one of said billers, and an identification of said party owing payment to said given one of said billers.

17. A system comprising:
a memory;
at least one processor operatively coupled to said memory; and
a persistent storage device operatively coupled to said memory and storing in a non-transitory manner instructions which when loaded into said memory cause said at least one processor to be operative to:
obtain, by an electronic bill presentment and payment system, from a given one of a plurality of billers, a cross-market unique bill payment code in accordance with a specification promulgated by an operator of said electronic bill presentment and payment system, said bill payment code uniquely identifying a bill of said given one of said billers;
obtain, by said electronic bill presentment and payment system, from an entity associated with a party owing payment to said given one of said billers for said bill of said given one of said billers, said bill payment code in accordance with said specification, together with associated bill payment information;
match, by said electronic bill presentment and payment system, said bill payment code obtained from said given one of said billers with said bill payment code obtained from said entity associated with said party owing payment to said given one of said billers; and
if said matching is positive:
cause said electronic bill presentment and payment system to initiate payment to said given one of said billers for said bill of said given one of said billers, in accordance with said associated bill payment information, and
cause said electronic bill presentment and payment system to initiate remittance information routing to said given one of said billers for said bill of said given one of said billers, in accordance with said associated bill payment information.

18. The system of claim 17, wherein said at least one processor is further operative to cause said electronic bill presentment and payment system to:
validate said bill payment code obtained from said given one of said billers; and
confirm said validation of said bill payment code obtained from said given one of said billers to said given one of said billers.

19. The system of claim 18, wherein said at least one processor is further operative to cause said electronic bill presentment and payment system to confirm said positive matching to said entity associated with said party owing payment to said given one of said billers.

20. The system of claim 19, wherein said entity associated with said party owing payment to said given one of said billers comprises a front end aggregator.

21. The system of claim 19, wherein said entity associated with said party owing payment to said given one of said billers comprises a mobile telephony service provider that is separate and distinct from said given one of said billers.

22. The system of claim 17, wherein said bill payment code comprises amount due, due date, an identification of said given one of said billers, and an identification of said party owing payment to said given one of said billers.

23. The system of claim 17, wherein said instructions on said persistent storage device comprise distinct software modules, and wherein said distinct software modules comprise a biller interface module, an entity interface module, and a matching module;
wherein:
said obtaining of said bill payment code from said given one of said billers is carried out by said biller interface module executing on said at least one processor;
said obtaining of said bill payment code and said associated bill payment information from said entity associated with said party owing payment to said given one of said billers is carried out by said entity interface module executing on said at least one processor; and
said matching is carried out by said matching module executing on said at least one processor.

24. An apparatus comprising:
means for obtaining, by an electronic bill presentment and payment system, from a given one of a plurality of billers, a cross-market unique bill payment code in accordance with a specification promulgated by an operator of said electronic bill presentment and payment system, said bill payment code uniquely identifying a bill of said given one of said billers;
means for obtaining, by said electronic bill presentment and payment system, from an entity associated with a party owing payment to said given one of said billers for said bill of said given one of said billers, said bill payment code in accordance with said specification, together with associated bill payment information;
means for matching, by said electronic bill presentment and payment system, said bill payment code obtained from said given one of said billers with said bill payment code obtained from said entity associated with said party owing payment to said given one of said billers; and
means for, if said matching is positive:
causing said electronic bill presentment and payment system to initiate payment to said given one of said billers for said bill of said given one of said billers, in accordance with said associated bill payment information, and
causing said electronic bill presentment and payment system to initiate remittance information routing to said given one of said billers for said bill of said given one of said billers, in accordance with said associated bill payment information.
